(19) United States
(12) Patent Application Publication
(10) Pub. No.: US 2009/0066172 A1
(43) Pub. Date: Mar. 12, 2009

(54) MAGNETIC MOTOR

(76) Inventor: William W. Landon, JR., Lebanon, CT (US)

Correspondence Address: MCCORMICK, PAULDING & HUBER LLP, CITY PLACE II, 185 ASYLUM STREET, HARTFORD, CT, 06103, US

(21) Appl. No.: 11/851,435

(22) Filed: Sep. 7, 2007

(51) Int. Cl. H02K 16/00; H02K 37/00

(52) U.S. Cl. 310/46

(57) ABSTRACT

A magnetic motor that comprises two assemblies, a rotor assembly (built up arrangement of rotor discs populated with permanent magnets) spaced in circular fashion on or about the disc and a stator assembly (built up arrangement of stator discs or planes populated with groups of permanent magnets spaced apart in circular fashion) so that the magnets on the rotor disc can move between the stator magnet groups in the same plane during rotation of the rotor assembly. The rotor (rotor discs) are connected to a common shaft (drive shaft) mounted on bearings to the mainframe to allow relative motion (rotation between the rotor and the stator).

### CROSS-REFERENCE TO RELATED APPLICATION

This application is related to U.S. Provisional Application No. 60/833,037, filed on Jul. 25, 2006, the disclosure of which is hereby incorporated by reference in its entirety.

### FIELD OF THE INVENTION

The present invention is directed generally to magnetic motors and more particularly to a motor using only permanent magnets as the power source to produce relative motion (rotation).

### BACKGROUND OF THE INVENTION

Prior magnetic motors typically provide motion (rotation etc.) using magnetic north or south pole faces, edges or relative elevations of faces or edges or combinations thereof and extensive shielding to produce motion.

This invention eclipses previous attempts by direct use of atomic forces separating the north and south poles of a magnet (magnets) by producing a virtual bipolar magnet (magnets) stator arrangement that allows movement of a rotor magnet (magnets) past and along and in the plane separating the poles while passing through the virtual center of symmetry (COS) of the virtual magnet (magnets) group arrangement.

The inventor has reasoned by observations of the universe and reason itself a method of producing continual motion with no apparent power source by inventing an equivalent magnetic circular rotating force field that is completely overlapping between magnets and never ending because the magnets are placed in circular arrangements so that any rotor magnet placed in the circular force field at point (a) can be moved to any next point (b) in the circular path by the combined overlapping and aiding attraction and repulsion forces acting on that magnet (magnets) to produce motion in the same direction.

The resulting power source is an equivalent single force field composed of overlapping ball-like shaped magnetic field structures where each ball shaped structure has no physical magnet (magnets) at the center of its structure to prevent passage of one magnet attracted and repelled by another to the center of the ball structure and then repelled and attracted to the next ball structure after passage through the center of the ball on a never ending point (a) to point (b) ball structure movement basis.

### SUMMARY OF THE INVENTION

In a first aspect of the present invention, a motor includes two assemblies—a rotor assembly and a stator assembly.

The rotor assembly includes a shaft (drive shaft) capable of bearing supports so that the shaft can rotate freely to which is mounted many discs which are phased to one another and spaced to fit into the stator assembly so that the discs can all rotate together on a common drive shaft within the stator assembly.

The stator assembly includes a main frame which is preferably round but other shapes (square, rectangular etc. will also do).

The stator assembly also includes bearings that will support a rotor shaft running through the stator center.

Rotor discs forming the rotor assembly are staggered within the stator assembly to form facing rotor disc, stator disc, rotor disc, stator disc, etc.

The rotor assembly further includes magnets equally spaced around the disc's rim and at other circumferences within.

The stator further includes magnets equally spaced around the stator disc's rim and at other circumferences within so that rotor disc magnets can pass by stator disc magnets in the same plane.

The stator disc magnets are arranged in macroatomic patterns to simulate the microatomic patterns of the barrier plane separating the north pole from the south pole in a magnet.

A space in the above patterns is purposely allowed so that a rotor magnet (magnets) can pass through this pattern in dead alignment with the barrier separating plane and complete the parallelogram structure of neutrons in the microatomic structure as simulated by the macroatomic stator magnetic pattern.

In a second aspect of the present invention both the rotor disc patterns and the stator disc patterns may be interchanged and this will allow more disc inertia for more resulting momentum and motor physical size reduction.

Also the arrangement of rotor/stator magnets in other configurations is acceptable as long as rotor/stator magnet patterns remain and the plane of operation is the neutron barrier plane separating the north pole from the south pole.

In the third aspect of the present invention, the motor operates both clockwise or counterclockwise depending on polarity patterns for both the rotor disc and stator disc.

Advantages of the magnetic motor embodying the present invention over prior magnetic motors are as follows:

1. Very powerful, can operate in the so-called cold fusion mode

2. Small size (no shielding)

3. Cost (no expense for shield or machining); can be built up of carbon composites, plastics etc., and cast and not machined

4. Only one moving part

5. No heat produced

6. Very long operating life

7. No fuel or electric current needed to power the motor, and

8. Easily installed—can be a throw away for replacement.

In conclusion, I have thought of the outer world and its relation to the universe and its arrangements and motions (stars, moons, planets, etc. rotating endlessly) and the thought of the inner world, the arrangement of atoms and its subatomic particles (neutrons, etc.) motions and realized the possibility that the magnet and its associated force fields is possibly the “Rosetta Stone” connecting these worlds.

With this in mind I have created a pseudo magnet (magnets) that has an endless magnetic force field with no magnet (magnets) located at its virtual atomic center of symmetry so that another magnet (magnets) can pass through this center without collision with another magnet (magnets) as real magnets do when attracted to their mutual centers of symmetry.

This pass through magnet (magnets) is used as the prime movement object in the present invention.

The invention of a magnetic motor run by magnetic interactions is based on the reasoning as follows:

1. Atomic force fields within the atom self propel the atom's component parts (neutrons, protons, electrons, etc.) in orbital (circular, rotational) motion about the atom's atomic center of symmetry with seemingly endless unlimited power forever unless acted upon by nuclear fission or fusion which destroys the atom's structural arrangement and the motion of the atom's components.

2. Most atoms in this universe are arranged in patterns that set the group of atoms in atomic arrangements to form matter that exhibits little or no external radiating force fields and whatever force field that is generated is unipolar.

3. Some atoms in this universe are arranged in patterns that set the group of atoms in atomic arrangements to form matter that exhibits large radiating force fields that are bipolar (namely magnets).

4. Magnets exhibit large attracting and repelling fields to certain metals and other magnets.

5. The magnetic fields of magnets must overlap for any interaction between the magnets.

6. The direction of the overlap sets the direction of magnet attraction or repulsion fields that move the magnets toward (attraction) or away (repulsion) from one another.

7. The force field of a magnet is shaped like a sphere with the magnet located at the center of this sphere.

8. The magnet has two planes both passing through the center of symmetry of the magnet and at right angles to one another that can radiate attraction or repulsion force fields.

These planes are:

a. The plane perpendicular to the pole faces and passing through the pole faces and aligned with the magnet's center of symmetry which I name the face plane.

b. The plane perpendicular to the face plane and passing through the magnets center of symmetry separating the north pole from the south pole or vice versa. (I call this the neutron plane N). The force vectors produced on this plane are infinitely small at the exact center of the barrier (I named neutron barrier plane N) passing through the atomic N center of symmetry.

Note—The face plane magnetic configurations used to power prior art magnetic motors is not used to produce motion in this invention because of inherent rotation instability and great difficulty to suppress (have to use shielding) forces that inherently act to oppose wanted direction of motion.

9. This motor uses the near field (close in, near touching) magnets (and many of them) and the problems associated with the face plane concept are eliminated by using the N plane concept of this invention. Note—The problems associated with air gaps for prior magnetic motor art pole face configurations are eliminated using the N plane concept of this invention.

10. Big or small objects are relative (a magnet compared to an atomic neutron or a magnet compared to the Sun).

11. Once an object (in this case, one or more rotor magnets) is set in motion in a force field, the object will tend to stay in motion in that force field unless acted upon by other force fields.

12. Once that object is set in motion that motion is forever (infinite) if the force field is forever.

13. The motion of the neutron is forever within the atom.

14. Magnets are materials composed of very dense configurations of neutron matter.

15. Neutrons are free to move about within the atom and move about to other atoms.

16. There are enough neutrons in certain matter to produce a magnet.

17. This type matter allows neutrons to move about and form a neutron barrier including closely packed neutron ball type spheres that is impenetrable by any force field.

18. This neutron barrier allows movement of neutrons into or out of the barrier in fourth dimension orthogonal figure eight motions to satisfy not only the barrier but the magnetic domains established by the barrier.

19. The neutron barrier contains a fourth dimensional hole or well shaped like a sector of two convex circles facing one another in the third dimension and viewed as such in the third dimension by viewing the spacing between the balls forming the neutron barrier that looks like a vase or tunnel.

20. It is this hole and the barrier structure moving in the fourth dimension to seal this hole and the forces involved to duplicate this movement using magnets as pseudo neutrons that is reasoned.

21. The parallelogram structure, the atomic Y cradle, the figure eight movement (F8), the eclipse, the shadow, the atomic hole or well (AH, AW), the atomic dwell (AD), the center of symmetry (COS) are concepts used in this invention.

22. Atomic attraction or repulsion is always along the COS direction between any two magnets.

23. The motor neutron barrier goes into its natural frequency atomic resonance wobbling the curve convolutes of the 4D field producing nearly unbounded atomic forces that are closely coupled to the motor's rotor assembly to generate nearly unbounded rotation and power.

24. I have discovered by reason and or invention that motion produced in this universe by two or more interacting (overlapping) force fields upon a third object possessing its own force field and interacting with the other two or more force fields by passing through with relative motion between them is along the direction of the diagonal of the parallelogram structural arrangement formed by the force fields when two or more force fields are overlapping to effect motion.

25. I have discovered by reason and or invention that this motion is symmetrical about a center of spherical symmetry regardless of the motion's direction.

26. I have discovered by reason and or invention that this direction is defined by three points in spherical space regardless of time and space and that the third point that defines this time and space relationship is at center of symmetry (COS) for that time and space and that this (COS) is at the center of the resulting time/space curvatures.

27. I have discovered by reason and or invention that time is a spherical entity as is space and both exhibit force fields not easily imagined.

28. The straight line motion of time and space and all other entities besides is also curved in the fourth dimension and all other dimensions that follow.

29. I have discovered by reason and or invention a means of making a hole in three dimensional space (3D space) that is used to produce a pseudo magnet with equivalent north and south pole magnetic effects about its center of symmetry (COS) with no magnet at its center.

30. The pseudo magnet (pseudo magnets) produced are guided by the 3D planes (XY, YZ) at right angles to one another in orthogonal space passing through the pseudo magnets (COS).

31. This invention uses the parallelogram structure arrangement pattern of the X, Y neutron plane and one disc is coupled to another disc's neutron plane by means of the hole in the atomic barrier structure that allows equivalent neutron movement along the parallel YZ plane or the next disc to intercouple the discs atomically to produce vast atomic power to drive the disc into motion (rotation).

32. I have discovered by reason and or invention that the time/space curvature of this motion produced is along the diagonal of the 3D parallelogram as defined by this invention.

The results of 1 through 32 is a magnetic motor run by magnetic interactions that can be used as a power source whose use is limited only by one's imagination.

### BRIEF DESCRIPTION OF THE DRAWINGS

FIG. 1 is a perspective view of a magnetic motor embodying the present invention.

FIG. 2 is an end view of the magnetic motor of FIG. 1 showing rotor/stator magnet alignment and position patterns.

FIG. 3 is an end view of the magnetic motor of FIG. 1 showing a parallelogram structure for a non-overlapping stator magnetic group.

FIG. 4 illustrates a parallelogram structure for an overlapping stator magnetic group.

FIG. 5 illustrates the parallelogram structure, the Y-cradle, the ab or ba path of motion along the diagonal of the parallelogram structure and the region of atomic dwell.

FIG. 6 illustrates repel and attract action on a rotor magnet moving from point a to point b or vice versa.

FIG. 7 illustrates in second dimensional view the movement of the rotor magnet of FIG. 6 as shown by fourth dimensional force.

FIG. 8 illustrates a stator magnet group repel and attract action on a plurality of rotor magnets.

### DETAILED DESCRIPTION OF THE PREFERRED EMBODIMENTS

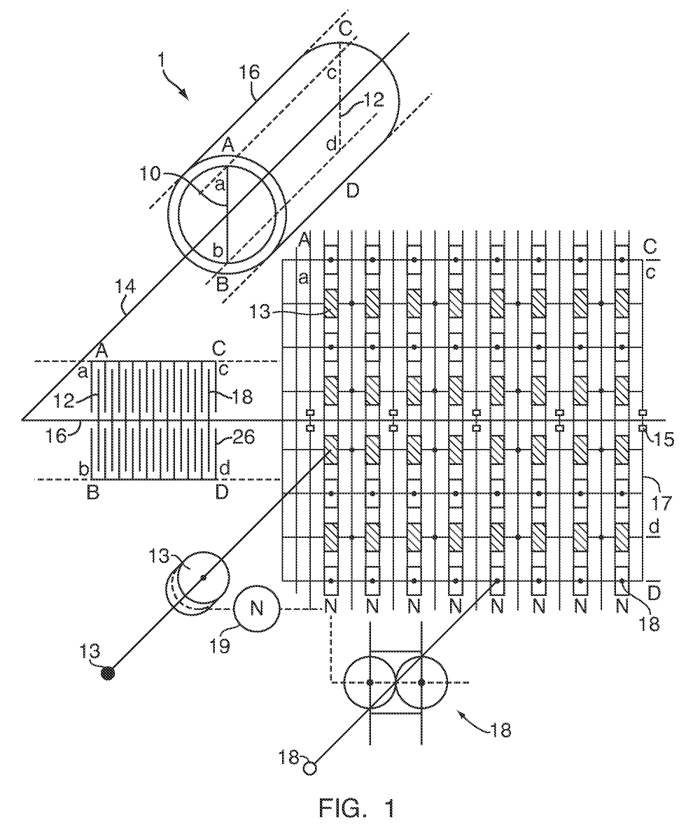

With reference to FIG. 1, a magnetic motor (motor) embodying the present invention is generally designated by the reference number 1. The motor includes an abcd rotor assembly 10 rotatably coupled to an ABCD stator assembly.

The rotor assembly 10 further includes disc (discs) 12 each including disc shaped magnet (magnets) 13. The rotor assembly 10 further includes a drive shaft 14 and bearings 15 to support the drive shaft.

Stator assembly 11 is mounted to a mainframe 16.

The stator assembly discs or planes 17 are populated with stator magnet group 18.

(Note—The neutron plane (N) defines the plane separating the north pole from the south pole or vice versa of any magnet and is the operating plane of all of the magnets used in the magnetic motor 1. This plane is magnetically neutral—i.e., does not attract or repel other magnets and forms an atomic track for other magnets passing by one another).

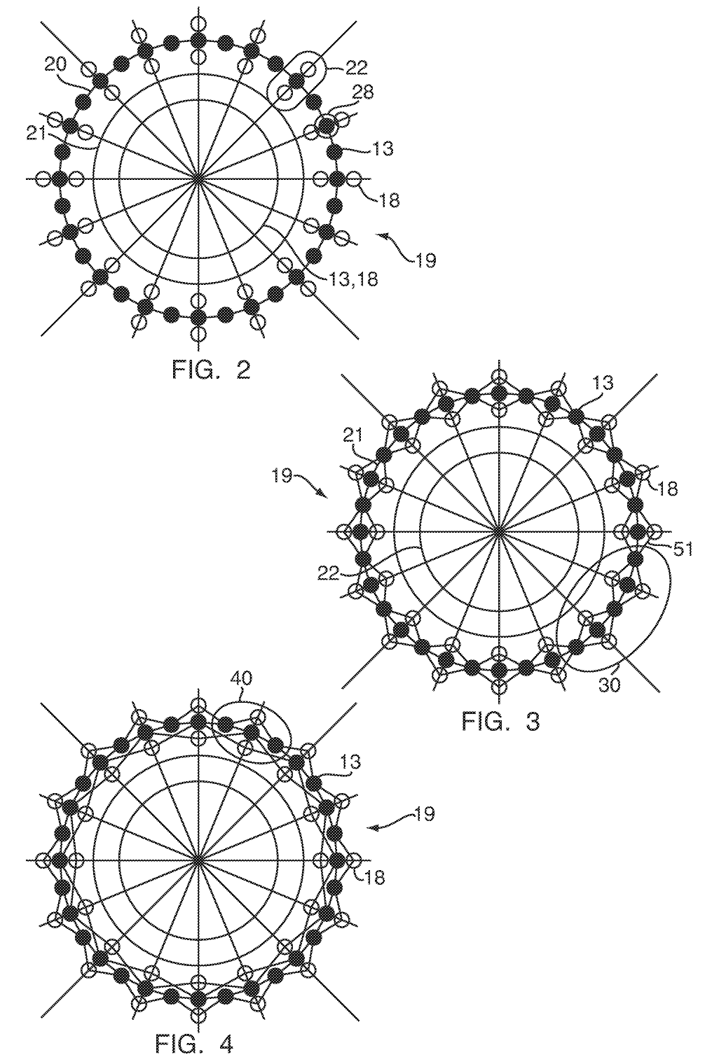

FIG. 2 shows the overview alignment and position patterns of any rotor magnet 13 passing any stator magnet 18.

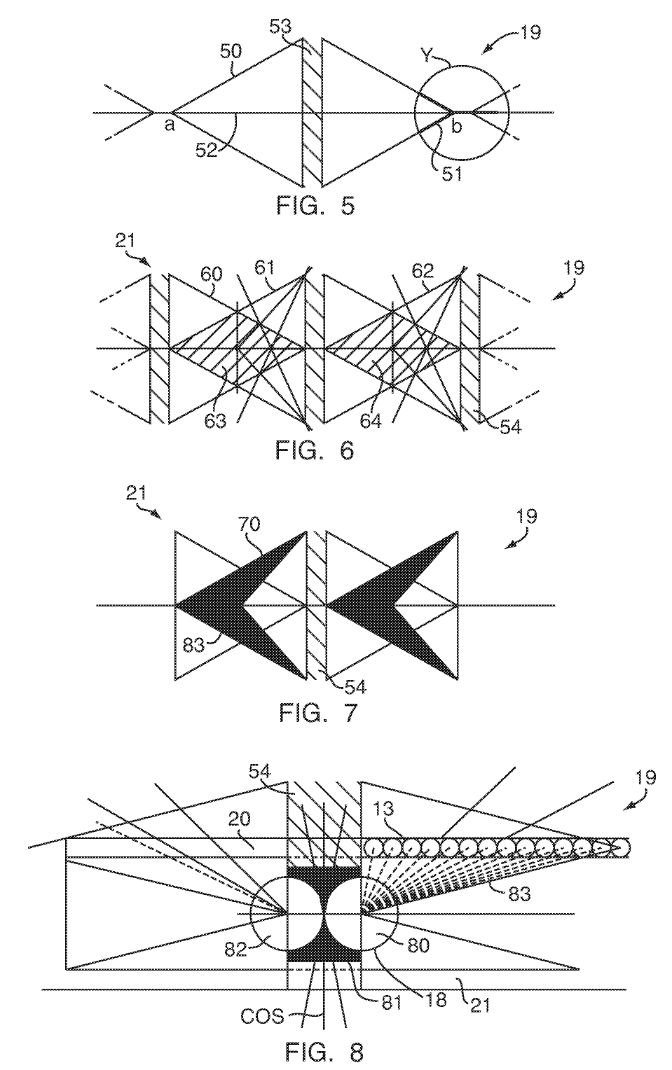

FIG. 3 shows a parallelogram structure 30 of FIG. 5 for a non-overlapping stator magnet group 18. Oscillations 30 define the FIG. 8 (F8) movement for non-overlapping mode.

FIG. 4 shows parallelogram structure 60, 61 and 62 of FIG. 6 for any overlapping stator magnet groups 18. Oscillations 40 define the F8 movement for overlapping mode.

FIG. 5 shows parallelogram 50, the Y 51, the ab or ba path of motion along diagonal 52 of the parallelogram 50 and the region of atomic dwell (AD) 53.

FIG. 6 shows parallelogram 61 overlapped by parallelogram 60 and parallelogram 62. Inner parallelogram 63 and parallelogram 64 show the regions of overlap for push (repel) pull (attract) action on the rotor magnet 13 traveling from point (a) to point (b) or vice versa.

If, for example, the rotor magnet 13 is traveling through the overlap region 63 from point (b) to point (a), the push of parallelogram 61 occurs simultaneously with the pull of parallelogram 60 to produce movement of the rotor magnet 13.

FIG. 7 illustrates the movement in FIG. 6 example as shown by the fourth-dimensional force 70 as viewed in the second dimension.

FIG. 8 illustrates the stator magnet group 18 push and pull or vice versa on a plurality of rotor magnets 13 within the range of the parallelograms 60, 61 and 62.

Entrance magnet 80 and exit magnet 82 or vice versa are eclipsed by ecliptic magnet 81 to the range of the atomic dwell (AD) 53 to eliminate any counter motion forces as any rotor magnet 13 moves through any stator magnet group pair 22.

(Note—Any ecliptic magnet 81 acts just like the eclipse of the sun or moon to light and block magnetic action in just the same way).

Any parallelogram 60, 61 contains lines of magnetic force (forces) 83 filling that parallelogram's volume. These magnetic forces 83 propel any rotor magnet 13 through group 22. The passageway of any rotor magnet 13 through any group 22 is a tunnel or atomic hole 23 that allows movement through group 22.

As will be recognized by those of ordinary skill in the pertinent art, numerous modifications and substitutions can be made to the above-described embodiments of the present invention without departing from the scope of the invention. Accordingly, the preceding portion of this specification is to be taken in an illustrative, as opposed to a limiting sense.

What is claimed is:

1. A motor comprising:
a common drive shaft;
a plurality of stator discs; and
a plurality of rotor discs coupled to and configured for spinning on the common drive shaft and staggered between the stator discs or stator planes with any of the rotor discs and stator planes respectively populated with rotor magnets and stator magnets about a circle or circles, the magnets of the rotor discs and stator planes being aligned with the plane of any magnet separating the north pole or south pole of that magnet.

2. The motor as defined in claim 1, wherein all of the rotor magnets are closely positioned about a circle or circles to overlap so that their magnetic fields overlap such that the positioning of the rotor magnets produces a continual never ending force field about a circle or circles on a rotor disc that the magnets occupy.

3. The motor as defined in claim 1, wherein all of the stator magnets are arranged in stator magnet groups positioned about a circle or circles to overlap any rotor magnet field.

4. The motor as defined in claim 3, wherein the stator magnets are arranged in any magnetic stator group such that their magnetic fields overlap.

5. The motor as defined in claim 3, wherein the stator magnet groups are positioned to overlap one another.

6. The motor as defined in claim 3, wherein any stator magnet group has an ecliptic magnet.

7. The motor as defined in claim 6, wherein the ecliptic magnet is configured and positioned to eliminate any backfield opposing forward motion.

8. The motor as defined in claim 7, wherein the stator magnet groups are configured such that between any pair of the stator magnet groups a tunnel or atomic hole exists for a rotor magnet to pass by in circular fashion.

9. The motor as defined in claim 8, wherein the stator magnet groups are configured such that a region of atomic dwell exists where no movement forces exist and no net motion is produced, the region of the atomic dwell being the equivalent region of passage through the north or south pole (COS) of a virtual magnet.

10. The motor as defined by claim 9, wherein a plurality of virtual magnets cooperate to produce an equivalent single magnet traveling endlessly through an equivalent atomic hole.

11. The motor as defined in claim 8, wherein the atomic hole or equivalent tunnel where rotor magnets pass through is a near exact model of the motion transfer of neutrons as neutrons move about to defend the neutron barrier separating the north and south poles of a virtual magnet equivalent stator pair magnetic field.

12. The motor as defined in claim 1, wherein the rotor magnets are configured for traveling endlessly in a circle or circles to produce a wobble or oscillation in figure eight fashion of a rolling stator magnetic field in the fourth dimension.
